(19) United States
(12) Patent Application Publication
(10) Pub. No.: US 2009/0192650 A1
(43) Pub. Date: Jul. 30, 2009

(54) Method for controlling enthalpy in air conditioning systems

(76) Inventor: Robert Brian Tonner, Pickering (CA)

Correspondence Address: ROBERT B. TONNER, 1590 GREENMOUNT STREET, PICKERING, ON, L1X 2H9, CA

(21) Appl. No.: 12/019,072

(22) Filed: Jan. 24, 2008

(51) Int. Cl. G05D 23/00; F25B 41/00

(52) U.S. Cl. 700/276; 62/207

(57) ABSTRACT

In an air conditioning system a method for controlling enthalpy in the environment of a structure is disclosed. The blower speed is controlled in such a manner as to maintain the prescribed dew point temperature of the air passing over the evaporator coils. When the air to be cooled contains high relative humidity, a greater quantity of latent heat is rejected into the evaporator, resulting in less sensible heat being rejected. This results in higher sensible temperature of air passing over the evaporator coils and thus the blower speed is reduced in and effort to maintain dew point. Maintaining the prescribed dew point ensures that the air in the space is continuously maintained at the optimum humidity levels without the use of humidity sensors. Enthalpy is determined by observing relative blower speed and the refrigeration compressor is modulated based on the blower speed.

### BACKGROUND OF THE INVENTION

The present invention relates to the cooling and dehumidification of buildings using air conditioning. The US Environmental Protection Agency cites the ASHRAE Standard 55-1992 Thermal Environmental Conditions for Human Occupancy, which recommends keeping relative humidity between 30% and 60%, with below 50% preferred to control dust mites

Dust mites generally live on shed human skin cells, which are pre-digested by the fungus Aspergillus repens. This fungus thrives above 70% RH. An average person sheds about 1.5 grams of skin a day (approximately 0.3-0.45 kg per year), which is enough to feed roughly a million dust mites. The house dust mite is one of the most significant sources of allergens, implicated in allergic asthma, rhinitis, conjunctivitis and dermatitis. One of the more important proteins responsible for the allergic reaction is DerP1, a protease digestive enzyme found in dust mite feces.

Typical air conditioning systems merely cool air without any regard for humidity. It is common in the industry for the air to be cooled to be forced across the evaporator coils at the fasted possible rate. This is done to prevent the ice build-up on the evaporator coils, which could possibly result in a catastrophic failure of the system. The downside of this action is that if the air to be cooled is of sufficiently high humidity the majority of energy rejected in the evaporator is latent heat. This results in air that is cooled somewhat, but not enough to cause condensation of the moisture in the air. When the cooled air is reintroduced to the space, it lowers the sensible temperature, but not the moisture content, resulting in an increase in relative humidity. The typically human response is to lower the thermostat set point so that the apparent comfort of lower temperatures can be reached, but this often results in a cold clammy feeling, all the time raising the relative humidity of the air and increasing the chances of growth of Aspergillus Repens and thus dust mites.

It is well recognized that humans and animals control their body temperature by sweating. At high humidity sweating is less effective so humans feel hotter. When relative humidity is ideal, temperatures in buildings can be raised during the air conditioning season without causing discomfort to the people in them. Humans, however, tend to react with discomfort to high dew points. Those accustomed to continental climates often begin to feel discomfort when the dew point reaches between 59 to 68° F. Most inhabitants of these areas will consider dew points above 70° F. to be oppressive. According to ASHRAE Standard 55-1992, as a practical matter, maintaining a space within a temperature range of 72.0° F.-80.0° F. and relative humidity of 30-50% will satisfy thermal comfort requirements of this standard in most cases.

Furthermore, when the temperature differential between the space to be cooled and the ambient air outside of the structure increases, the rate of heat gain by the air in the space increases, and as a result so does the energy cost related to cooling the space. According to Florida Power and Light the average costs in the year 2006 of cooling a 2000 square foot home costs $188 per month at 70° F., but when that temperature is raised to 75° F. the cost drops to $143, and furthermore when the temperature is raised to 80° F. the monthly cost drops to $98.

Gulf states experience very high humidity in the months from April until October. While the sensible outside temperature in Florida rarely exceeds 88° F. during these months, the average dew point is regularly above 70° F.

The use of humidity sensors in the space to be conditioned poses problems, especially where the air conditioning in a structure is being retrofitted. It is often the case that the wiring used for carrying control signals from the space to the air conditioning system is limited and therefore the addition of a humidity sensing signal may require a significant change to the structure's wiring, which is often embedded within fixed walls.

Furthermore, humidity sensors are known by those skilled in the art to be expensive and delicate, or conversely, inexpensive and inaccurate.

The effects of excessive humidity on residential cooling can be seen in the following example. In high humidity zones of the U.S. such as Florida, the dew point of ambient air regularly exceeds 70° F. in the summer months. It is often the case that residential air conditioning systems are oversized and air is passed over the evaporator at very high speeds in order to ensure that the home will be cooled on the hottest days. The result is that the system cools the house by passing a large volume of air over the evaporator coils with a small drop in sensible temperature in the air, quite possibly just below the set point. For instance a space has an air temperature of 75° F. with a dew point of 70° F. and therefore a relative humidity of 85%. If the thermostat set point is 73° F. the thermostat will signal the air conditioning system to begin cooling air. Warm moist air is drawn into the return air ducts, and passes over the evaporator. Since the moisture level is so high, the larger portion of heat that is rejected into the evaporator is latent heat, but since the air is moving so quickly, it is not sufficient to drop the delivered air temperature much below 65° F. This delivered air temperature will cool the space sufficiently to eventually reach the set point of 73° F. Since the delivered air is 65° F. and this is below the original dew point of 70° F., some moisture has been removed. Over the course of several cooling cycles the new dew point of the air in the structure would be 65° F. This would result in room ambient temperature of 73° F. and a relative humidity of approximately 72%. While this is a reduction from 85%, it is far from the ideal for human comfort and safety with regard to fungus growth.

Now, the present invention, which will be disclosed in greater detail later herein, in the same application would produce different results. Once again, since the moisture level is so high, the larger portion of heat that is rejected into the evaporator is latent heat, but since the air is moving so quickly, it is not sufficient to drop the temperature much below 65° F. Therefore, the present invention would operate to retard the air speed such that the sensible temperature of air passing over the coils is lowered to 50° F. This delivered air temperature will cool the space sufficiently to eventually reach the set point of 73° F., but since the delivered air is 50° F. and this is below the original dew point of 70° F., a greater degree of moisture has been removed. Over the course of several cooling cycles the new dew point of the air in the structure would be 50° F. This would result in room ambient temperature of 73° F. and a relative humidity of approximately 45%, which is well within the human comfort zone and well below the level required to sustain mould and fungus growth.

Furthermore, since the air is much drier as a result of the operation of the present invention and moisture from human skin will evaporate and liberate heat more readily, the occupants are more likely to raise the set point to achieve comfort. This will result in energy savings.

As another benefit of the present invention, the evaporator coils are protected from freezing up because the air temperature, which is closely related to the surface temperature of the evaporator coils always maintains a generous buffer of at least 15° F. above the point where frosting would occur on the surface of the evaporator.

### DESCRIPTION OF THE PRIOR ART

While it can be seen by a thorough study of prior art that varying blower speed to control delivered air temperature or other useful measured parameters has been taught by other inventors, and that air conditioning systems can be useful in removing moisture from the air, it is clear that the use of strict control of delivered air temperature to continuously control total enthalpy is not obvious to those skilled in the art.

In prior art, U.S. Pat. No. 3,367,408 to Moreland discloses an apparatus to control the speed of a blower relative to the temperature of the air in heat transfer relationship with a heat exchanger. Moreland provides a sensor responsive to the temperature of the delivered air and an apparatus to control speed of the blower, but stops short of addressing enthalpy. While Moreland's apparatus was effective in controlling temperature I humbly submit that the broad nature of his claim did not anticipate strict dew point control to deter the growth of Aspergillus Repens. Additionally, Moreland provided adjustment means to merely allow the apparatus to be used with various types of equipment.

In U.S. Pat. No. 3,785,433, Ballard discloses a method to use a temperature responsive switch in the air stream. The bimetallic switch selects a higher speed when the sensed air temperature drops below a specified limit. Ballard does not address enthalpy, or humidity control.

In U.S. Pat. No. 4,873,649 to Grald discloses a complex mathematical approach in a method that attempts to maintain thermal comfort in an occupied space by using a plurality of sensors within the space. Grald's method converts a user's inputs to a comfort index and then adjusts equipment-operating parameters based on this index.

In U.S. Pat. No. 4,003,729 to McGrath discloses an invention that is operable during times when the room thermostat is not signalling for the air conditioning system to cool the space. The invention hinges on a humidity sensor in the space to be conditioned that, when the system is not cooling, will activate the air conditioning system at a reduced air speed to improve dehumidification. McGrath teaches that the speed of the air passing over the evaporator can be controlled to provide dehumidification while avoiding sensible cooling of the space and still preventing damage to the system caused by frosting of the evaporator.

### SUMMARY OF THE INVENTION

Accordingly it is therefore an object of the present invention to strictly control the maximum humidity in a space without the use of humidity sensors in the airflow ducts or in the space to cooled, especially in high humidity warm climates in order to dramatically reduce Aspergillus Repens and thus to control the growth of dust mite populations and ultimately reduce some of the causes of asthma and other related conditions.

It is a further object of the present invention to strictly limit relative humidity so that the human response will be to raise the set point of the cooling thermostat in order to reduce heat gains and thereby reduce energy costs associated with cooling.

It is yet another object of the invention to permit continuous dehumidification in direct connection with, and during occupied space cooling.

It is yet anther object of this invention to prioritize the rejection of latent heat over sensible heat to the extent that the space is dehumidified first, and then sensibly cooled.

It is yet another object of this invention to provide a means to adjust the operation of the air conditioning compressors that have a variable output capacity to closely match the needs of the system in order to reduce energy consumption and maximize occupant comfort.

### DESCRIPTION OF THE DRAWINGS

Other objects and advantages will become apparent to those skilled in the art as this specification of the invention is disclosed in detail with reference to the drawings in which like numerals have been used to designate like elements throughout and wherein.

FIG. 1 is a diagrammatic representation of an air conditioning system, which embodies the principles of the present invention.

FIG. 2 is a flow chart showing the logical operation of the disclosed method.

FIG. 3 is a schematic component diagram showing in greater detail the embodied principles of the present invention.

FIG. 4 is a psychrometric chart used by those skilled in the art to identify the properties of air. The chart has been modified to show the characteristic zones of mould and dust mite growth, typical air conditioning zones and the properties of air resulting from the present invention.

FIG. 5 is an extraction from FIG. 4 showing the detail properties of air resulting from the present invention.

FIG. 6 is a further amplification of FIG. 5 showing the properties of the Enthalpy Control Zone resulting from the present invention as compared to the ideal environmental properties suggested by ASHRAE Standard 55-1992.

### DETAILED DESCRIPTION OF THE PREFERRED EMBODIMENTS

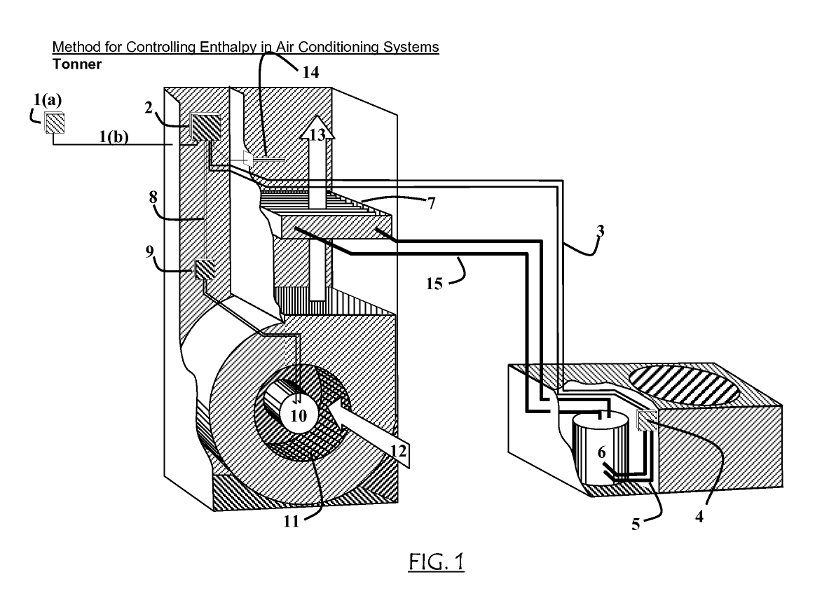

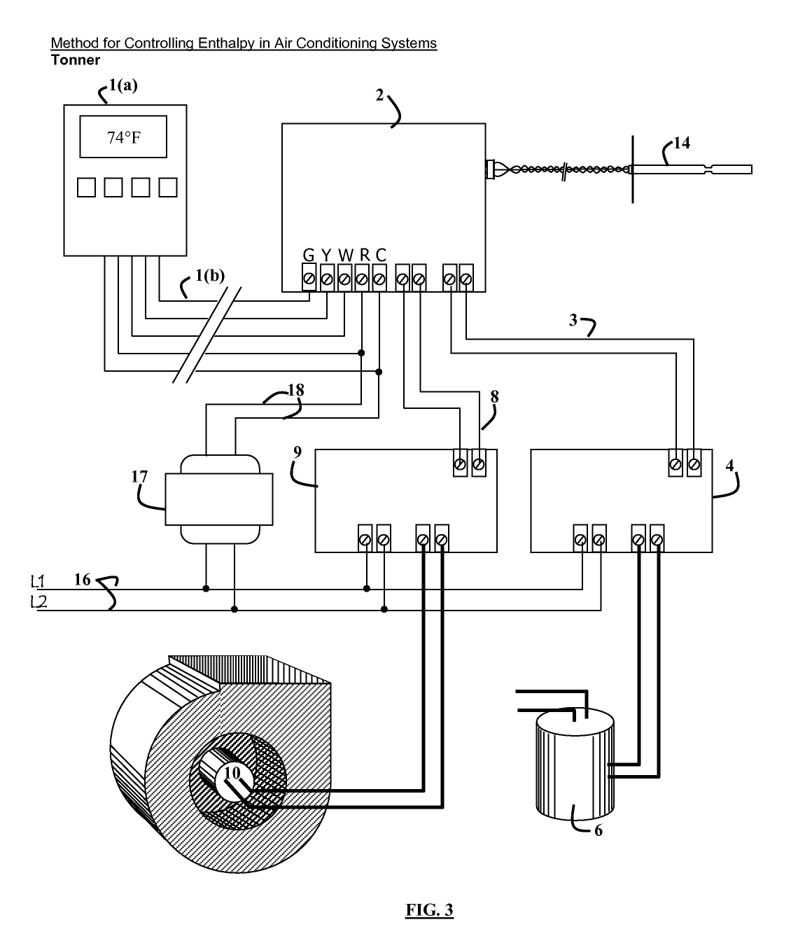

Now, with reference to FIG. 1 there is disclosed an air conditioning system which is well known to those skilled in the arts. Signal and control wiring is simplified for the purposes of this drawing in order to disclose the relationships of the devices and the method. Wiring means to provide electrical power are well known to those skilled in the arts and are not an object of this invention. Signal wires are also simplified and shown in greater detail in FIG. 3. The room thermostat 1(a) monitors room sensible air temperature and the desired room temperature set point as defined by the occupant. Upon detecting air temperature above the set point the thermostat 1(a) closes an internal switch, providing a control signal via thermostat wires 1(b) to enthalpy control unit 2. Enthalpy control unit 2, which is microprocessor based controller known to those skilled in the art, provides a control signal via the compressor control wires to the compressor actuating means 4. Compressor actuating means 4 energizes compressor 6 via power wires 5. Compressor 6 pumps compressed refrigerant via supply line 15 to evaporator coil 7. Enthalpy control unit 2 then provides variable control signal to blower actuating means 9. Blower actuating means energizes blower 10, which propels return air from occupied space across evaporator 7. Supplied air 13 is sensed by temperature responsive means 14 to determine the sensible temperature of the supplied air after having passed over the evaporator coil. Enthalpy controller 2 receives control signal from temperature responsive means 14 in response to said sensible supplied air.

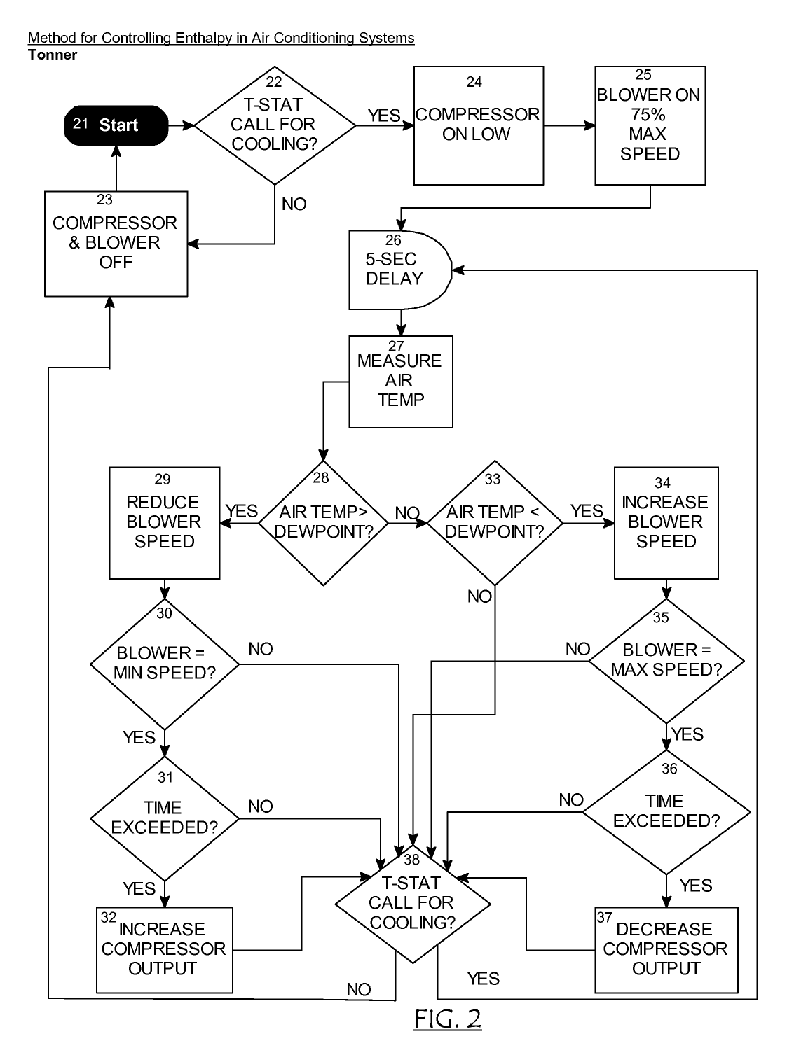

Now, turning to FIG. 2 we can observe the method of the disclosed invention. Beginning at the logical block 21 START we move to logical block 22. If the sensible temperature in the occupied space is below the set point the method proceeds to logical block 23. The instruction to de-energize the compressor and blower is generated, and the process returns to logical block 21 where, if the sensible temperature in the occupied space is below the set point, the method proceeds to logical block 24. At logical block 24 the instruction to energize the compressor at its lowest capacity is generated. Moving on to logical block 25 the instruction to energize the blower at seventy-five percent of its maximum speed is generated. Continuing on to logical block 26 a delay period is entered to allow the blower to ramp up to speed and to obtain a temperature signal indicative of the new blower speed. At logical block 27 the supply air temperature is taken and in logical block 28 it is compare to determine if it is greater than the prescribed dew point. If the temperature is greater than the dew point the method proceeds to logical block 29 where the instruction to reduce blower speed is generated. At logical block 30 the method compares the new blower speed with the minimum blower speed. If the minimum blower speed has not been reached, the method proceeds to logical block 38. At Logical block 38 the method once more checks to see if the room thermostat is signalling for cooling. If it is, the method returns to logical block 26. If the thermostat is no longer signalling for cooling then the process returns to logical block 23.

Returning now to logical block 30, if the minimum blower speed has been reached in logical block 30 the method proceeds to logical block 31 to determine if the minimum blower speed has been sustained for a prescribed period of time. If the minimum blower speed has not been sustained for the prescribed period the method progresses to logical block 38 and continues as described above. Once the stabilization period of block 31 has been completed at minimum speed, the method proceeds to logical block 32 where the instruction to increase compressor output is generated. Once this is complete, the method progresses to logical block 38 and so on.

Now, returning to logical block 28, if the temperature is not greater than the dew point the method proceeds to logical block 33 where the temperature is again checked against dew point. If the temperature is less than the dew point, the method proceeds to logical block 34 where the instruction to increase blower speed is generated. At logical block 35 the method compares the new blower speed with the maximum blower speed. If the maximum blower speed has not been reached, the method proceeds to logical block 38. At Logical block 38 the method once more checks to see if the room thermostat is signalling for cooling. If it is, the method returns to logical block 26. If the thermostat is no longer signalling for cooling then the process returns to logical block 23.

Returning now to logical block 35, if the maximum blower speed has been reached in logical block 34 the method proceeds to logical block 36 to determine if the maximum blower speed has been sustained for a prescribed period of time. If the maximum blower speed has not been sustained for the prescribed period the method progresses to logical block 38 and continues as described above. Once the stabilization period of block 36 has been completed at maximum speed, the method proceeds to logical block 37 where the instruction to decrease compressor output is generated. Once this is complete, the method progresses to logical block 38 and so on.

Now turning to FIG. 3 we can see in greater detail the preferred apparatus for the embodiment of the method of the present invention as described in FIG. 1, specifically the wiring of electrical power. Power lines 16 represent single-phase mains power. The mains are fed to blower actuating means 9 and to the compressor actuating means 4, and to class-two transformer 17 which steps mains voltage down to twenty-four volts AC supplied on low voltage power lines 18. The low voltage is supplied to thermostat 1(a) via thermostat wiring 1(b).

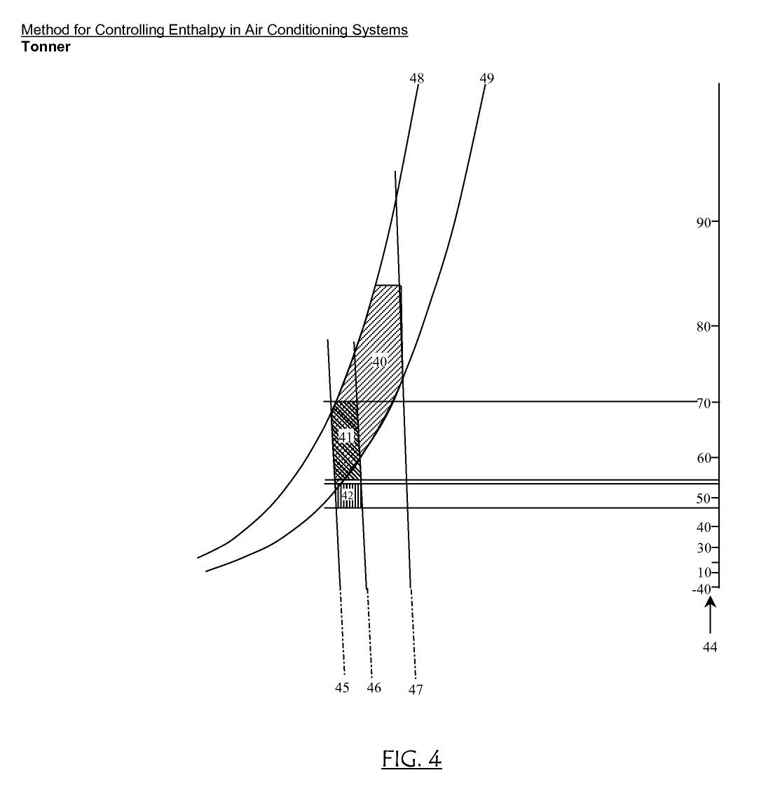

FIG. 4 discloses an extraction from the psychrometric chart published by ASHRAE and well known to those skilled in the art. Horizontal lines on the chart represent dew point temperatures as indicate on dew point scale 44. Quasi-vertical line 45 represents sensible room air temperature of 72° F. Similarly line 46 represent sensible room air temperature of 80° F., and line 47 represents sensible room air temperature of 90° F. Curved line 48 represents 90% relative humidity and curved line 49 represents 50% relative humidity.

The chart graphically depicts air conditions and compares the results of the present invention against unconditioned air region in Risk Zone 40 and typical Air-Conditioning Zone 41. Risk Zone 40 depicts the conditions of ambient air common in high humidity areas of the US and Canada during the summer months. These are the conditions for optimum fungus and dust-mite population growth. Risk Zone 40 boundaries are not limited to, but are commonly found to be above 72° F. and from 50% to 90% RH.

Air Conditioning Zone 41 depicts the result of common air conditioning systems. If the air conditioning system does not control dew point it is allowed to vary depending on cooling load. As a result the upper limit delivered air temperature, and thus dew point of excess moisture, of Air Conditioning Zone 41 can commonly reach 70° F. and may go as low as 55° F. Using the common temperature settings of 72° F. to 80° F. Air Conditioning Zone 41 maintains sensible room temperature but also maintains humidity from 40% RH to as high as 90% RH. The bulk of Air Conditioning Zone 41 overlaps with Risk Zone 40 and is therefore in the prime growth area for fungus, moulds and mites.

Enthalpy Control Zone 42 results from the present invention. The vertical lines represent the same temperature range as in Air Conditioning Zone 41. Since the delivered air temperature is strictly controlled between 47° F. and 54° F. more latent heat is rejected into the evaporator, causing increased condensation of excess moisture. When the air is reintroduced back into the space to be cooled it is much drier than if the delivered air temperature is not strictly controlled in this range.

Since it is well known that significantly more energy is rejected into the evaporator due to the phase change of water vapour compared to sensible cooling only, it will be apparent to one skilled in the art that the greater the degree of moisture in the air, the less sensible temperature reduction will result and the delivered air will tend toward higher temperatures. The present invention will respond by slowing the blower to maintain the delivered air temperature and thus maintain a controlled rate of condensation.

It will also be apparent to one skilled in the art that, as the moisture levels in the return air supply begin to drop the quantity of latent heat rejected due to phase change will also reduce. This will cause more sensible heat to be rejected into the evaporator causing the delivered air to drop in temperature. The present invention will respond by increasing blower speed to maintain delivered air temperature.

Turning to FIG. 5 there is disclosed a more detailed graphical depiction of the temperature and humidity conditions of the present invention. Vertical line 50 represents the low limit of the recommended room ambient temperature range for human comfort of 72° F. Line 51 is the upper limit of said range and represents 80° F. Horizontal Line 52 is the lower limit of 47° F. in the Enthalpy Control Zone of the controlled delivered air temperature, while line 53 is the upper limit of 54° F. in said Zone.

Curved Line 54 depicts 30% relative humidity which is the lower limit of the Humidity Range recommended by ASHRAE and Curved Line 56 depicts 50% relative humidity which is the upper limit of said humidity range.

It can be observed by one skilled in the art that the Enthalpy Control Zone of the present invention is defined by lines 50, 51 52 and 53.

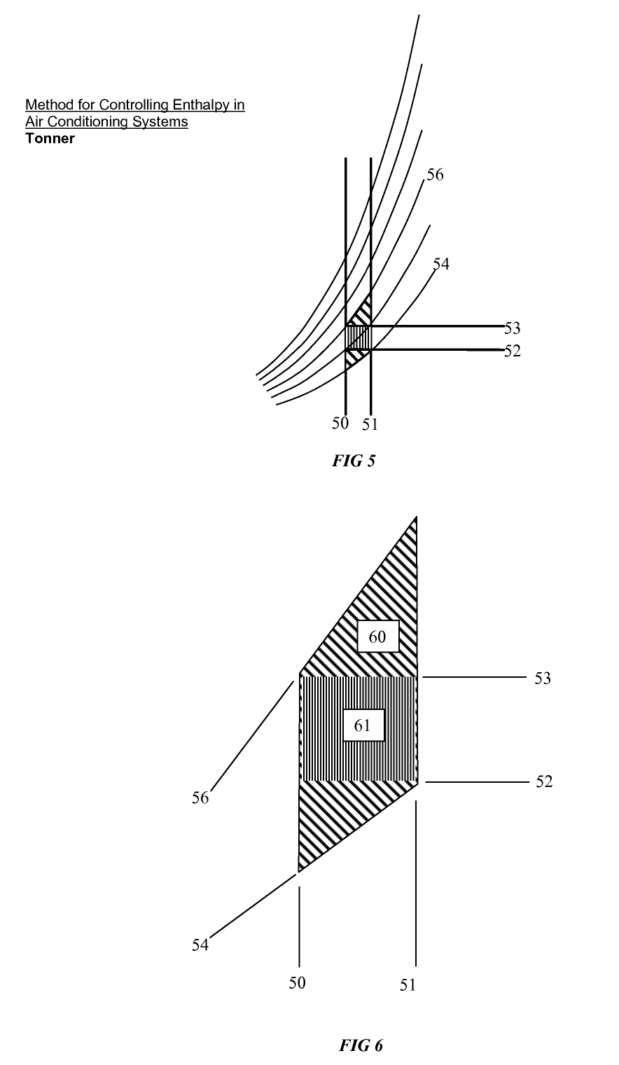

Turing to FIG. 6 it can be seen that the Enthalpy Control Zone 60 will maintain conditions in the occupied space well within the Ideal Conditions 61 prescribed by ASHRAE Standard 55-1992.

While the preferred embodiments of the present invention have been disclosed and illustrated, the invention should not be limited thereto, but may be otherwise embodied within the scope of the above claims.

I claim:

1. In an air conditioning system comprising:
a temperature responsive sensor in the occupied space to be cooled that provides a temperature responsive control signal to activate
a mechanical refrigeration compressor having a variable output capacity operatively coupled to
an evaporator within the supply air duct, and
an actuating means to select said capacity of said compressor, and
a blower to route air in heat transfer relationship with said evaporator,
and variable speed actuating means to drive said blower
a method to control enthalpy and compressor output capacity in the environment of a structure, which comprises:
a. a temperature responsive means to determine the sensible temperature of the supplied air after having passed over the evaporator coil;
b. a means to generate a control signal in response to said sensible supplied air temperature including the means to vary said signal as said sensible temperature varies
c. a means to supply said variable control signal in response to said sensible supplied air to said blower actuating means to vary the output of said actuating means and thus the speed of said blower, whereby said blower speed is modulated to maintain a prescribed dew point of said supplied air such that said blower speed is reduced when said determined temperature of said supplied air exceeds said dew point and said blower speed is increased when said sensed temperature of said supplied air is below said dew point;
d. a means to calculate latent heat load relative to compressor output capacity as a function of said resultant blower speed;
e. a means to generate a second control signal in response to said calculated relative latent heat load, and
f. a means to supply said second control signal to said actuating means of said variable output compressor to vary said output capacity of said compressor in response to said calculated relative latent heat load

2. A method as set forth in claim 1, which comprises a temperature responsive means positioned in the supply air duct so that means to generate a control signal will generate a control signal in response to said supply air after said air supply has been effectively cooled by said evaporator.

3. A method as set forth in claim 1, as an alternative embodiment to the temperature responsive means as set forth in claim 2, a temperature responsive means positioned on the refrigerant return lines such that means to generate a control signal will generate a control signal in response to the temperature of said refrigerant after it has absorbed heat rejected by said air supply at said evaporator such that the sensible temperature of said supply air passed over the evaporator can be extrapolated.

4. A method as set forth in claim 1, wherein said dew point of said supply air is between forty-seven and fifty-four degrees Fahrenheit when said air conditioning system is energized for the purpose of cooling the air in the structure.

5. A method as set forth in claim 1, wherein:
a. said means to calculate latent heat load relative to compressor output capacity is determined by:
i. the latent heat rejection into said evaporator is inversely proportional to said speed of said blower,
ii. the minimum blower speed is indicative of maximum latent heat rejection, and conversely
iii. the maximum blower speed is indicative of minimum latent heat rejection.

6. A method as set forth in claim 5 wherein:
a. said maximum blower speed is the speed that the blower will attain when all available power is applied, and
b. said minimum blower speed is approximately fifty percent of said maximum blower speed.

7. A method as set forth in claim 1, wherein:
a. said second control signal will vary to said actuating means of said variable output compressor and thus increase said output capacity of said variable output compressor when said maximum allowable latent heat rejection has been attained and sustained for a stabilization period, and
b. said second control signal will vary to said actuating means of said variable output compressor and thus decrease said output capacity of said variable output compressor when said minimum allowable latent heat rejection has been attained and sustained for said stabilization period.

8. A method as set forth in claim 7 wherein said stabilization period is a time is between one and ten minutes.

9. A method calculate total system relative latent heat load, comprising the steps of:
i. Calculating a ratio of compressor output to relative to said maximum compressor output capacity,
ii. Calculating a ratio of blower speed to said maximum blower speed,
iii. Calculating total system relative latent heat load as the product of said ratio of compressor output to relative to said maximum compressor output capacity, and said ratio of blower speed to said maximum blower speed.

10. A method as set forth in claim 9 wherein said maximum compressor output capacity is the output that the compressor can deliver when all available power is applied to all mechanical input sources to said compressor, wherein said compressor may be of the following compressor varieties:
a. a single compressor comprising a single motor with infinitely variable output,
b. a single compressor with a single motor comprising a variable output of a finite number of stages,
c. a plurality of compressors with a plurality of motors with a plurality of output stages, or
d. a combination of said varieties of compressors.

11. In an air conditioning system comprising:
a temperature responsive sensor in the occupied space to be cooled that provides a temperature responsive control signal to activate
a mechanical refrigeration compressor having a fixed output capacity operatively coupled to
an evaporator within the supply air duct, and
a blower to route air in heat transfer relationship with said evaporator,
and variable speed actuating means to drive said blower,
a method to control enthalpy in the environment of a structure, which comprises:
a. a temperature responsive means to determine the sensible temperature of the supplied air after having passed over the evaporator coil;
b. a means to generate a control signal in response to said sensible supplied air temperature including the means to vary said signal as said sensible temperature varies
c. a means to supply said variable control signal in response to said sensible supplied air to said blower actuating means to vary the output of said actuating means and thus the speed of said blower, whereby said blower speed is modulated to maintain a prescribed dew point of said supplied air such that said blower speed is reduced when said determined temperature of said supplied air exceeds said dew point and said blower speed is increased when said sensed temperature of said supplied air is below said dew point, and
d. said dew point of said supply air is between forty-seven and fifty-four degrees Fahrenheit when said air conditioning system is energized for the purpose of cooling the air in the structure.

12. A method as set forth in claim 11, which comprises a temperature responsive means positioned in the supply air duct so that means to generate a control signal will generate a control signal in response to said supply air after said air supply has been effectively cooled by said evaporator.

13. A method as set forth in claim 11, as an alternative embodiment to the temperature responsive means as set forth in claim 12, a temperature responsive means positioned on the refrigerant return lines such that means to generate a control signal will generate a control signal in response to the temperature of said refrigerant after it has absorbed heat rejected by said air supply at said evaporator such that the sensible temperature of said supply air passed over the evaporator can be extrapolated.
